(19) United States
(12) Patent Application Publication
(10) Pub. No.: US 2009/0019773 A1
(43) Pub. Date: Jan. 22, 2009

(54) DRIVE DEVICE FOR A MOTOR VEHICLE DOOR, IN PARTICULAR A SLIDING DOOR

(75) Inventors: Klaus Gruhn, Monchengladbach (DE); Margret Gruhn, Monchengladbach (DE); Holger Schiffer, Meerbusch (DE)

Correspondence Address: Omori & Yaguchi USA, LLC;8 Penn Center, 1628 John F. Kennedy Blvd, Suite 1300, Philadelphia, PA, 19103, US

(73) Assignee: Kiekert Aktiengesellschaft, Heiligenhaus (DE)

(21) Appl. No.: 11/629,967

(22) PCT Filed: Jun. 16, 2005
(86) PCT No.: PCT/DE05/01071

§ 371 Date: Jan. 4, 2008

(30) Foreign Application Priority Data
Jun. 16, 2004 (DE) 10 2004 028 760.0

(51) Int. Cl. E05F 15/14; B60J 5/04

(52) U.S. Cl. 49/28

(57) ABSTRACT

The object of the invention is a drive system for a motor vehicle door (1), in particular a sliding door (1). This comprises a drive motor (4) and a connected drive means (6, 7, 8, 9) for moving the motor vehicle door (1) along an opening/closing path (R). According to the invention, a gear (5) or generally a torque converter is provided between the drive motor (4) and the drive means (6, 7, 8, 9), said gear or torque converter acting with different torques on the drive means (6, 7, 8, 9) depending on a respective load and/or signal.

### FIELD OF THE INVENTION

The invention refers to a drive system for a motor vehicle door, in particular a sliding door, comprising a drive motor with a connected drive means for moving the motor vehicle door along an opening/closing path. The opening/closing path generally refers to the path of the motor vehicle door or its opening/closing movement during its entire opening and closing operation. The opening/closing path is generally predetermined by one (or several) guide rail(s).

### BACKGROUND OF THE INVENTION

Today, such drive systems are increasingly used for sliding doors in motor vehicles which can, for instance, be operated by a remote control. This means that the obligatory drive motor—in most cases an electric motor—ensures that the motor vehicle door or sliding door is automatically opened and closed (and by remote control). Examples of such sliding door drives are described in DE 43 41 153 A1, EP 0 040 631 B1, DE 35 38 837 A1 and WO 99/09282 A1.

According to the prior art of DE 196 07 552 A1 on which the invention is based, a drive means comprising a reducing gear as well as a reel for winding and unwinding a cable is provided.

The prior art has generally been tried and tested, does however have the disadvantage that in addition to the described drive system a door closing assistance or similar is required in most cases for moving a vehicle door or sliding door from its pulled closed state into the closed position—in most cases against the force of the rubber seal around the door opening.

At this point EP 0 040 631 B1 does, for instance, suggest that the drive motor or the electric motor comprises a first and second exciting coil. The second exciting coil is switched on to provide sideways movement of the door or sliding door regularly associated with said adoption of the closed position and to provide additional power output. This is costly as a specially matched motor must be used.

DE 196 07 552 A1 describes a similar costly solution for which an additional sliding door closer is required. DE 35 38 837 A1 provides a similar solution with separate cable pulls.—The invention aims to remedy this situation.

### SUMMARY OF THE INVENTION

The invention is based on the technical problem of improving such a drive system for a motor vehicle door and in particular a sliding door so that a fault-free operation is guaranteed with a relatively simple design.

In order to solve this technical problem, a drive system is characterized in that a gear or generally a torque converter is provided between the drive motor and the drive means, acting with different torques on the drive means, depending on the load and/or signal. Preferably the respective gear is a planet gear with individual gear members, which when reverting to an actuating means provide a coupling depending on the desired torque. In other words, the actuating means ensures that individually selected gear members (of the planet wheel gear) are coupled depending on the output-side load or depending on an actuating and/or sensor signal.

Said actuating means may produce the described coupling of the selected gear members by means of a spring and/or an actuator. As usual, the planet gear and/or planet wheel gear comprises at least a ring gear, a planet carrier, planet wheels and a sun wheel. Said gear is regularly connected to the drive means with its sun wheel, whilst the drive motor acts on the planet carrier or the ring gear.

The actuating means may act upon the ring gear to produce different torques of the said gear. In addition or alternatively, the actuating means can also act upon the planet carrier. In any case, the actuating means ensures that the gear member acted upon, generally the ring gear or planet carrier, is blocked or released. In case of the blocked gear member, the torque is increased on the output side so that the desired increased torque is available at the sun wheel and the connected drive means. When, however, ring gear or planet carrier are able to rotate freely, basically no torque changeover takes place, as the respective gear acts like a continuous rigid connection between the drive motor and drive means.

The differentiation based on different torques takes into account that the opening/closing path of the motor vehicle door, i.e. the path followed by the motor vehicle door or stipulated by at least one guide rail during opening and closing comprises mainly a closing path and a pulling closed path, in which both said paths are, according to the invention, completed with different gear torques. Generally, the described 1:1 gear ratio will be used for the closing path, produced by the respective gear or planet gear representing a quasi-rigid connection between the drive motor and the drive means without torque changeover. This functional state takes into account the conditions of the closing path for the motor vehicle door, which should be completed as quickly as possible. At the same time, no increased loads are expected, as along the closing path the door moves mainly parallel to the motor vehicle body in line with the guide rail.

At the end of the closing paths the motor vehicle door moves into the pulling-closed path mainly corresponding to a sideways movement of the motor vehicle door. During this sideways movement, the motor vehicle door leaves its protruding position parallel to the motor vehicle body and is, for this purpose, mainly moved vertically into the respective and accommodating opening. This pulling-closed path regularly follows the closing path when a motor vehicle door latch on the motor vehicle door assumes a locked position (first position or primary position) of its locking mechanism with regard to a locking bolt on the vehicle car body side. Naturally, the reverse arrangement is also possible, i.e. with the motor vehicle door latch being arranged on the motor vehicle body and the locking bolt on the motor vehicle door.

In any case, the adoption of a defined position of the motor vehicle door compared to the motor vehicle body or the locked position of the motor vehicle door latch ensures that the closing path moves into the pulling closed path. Adoption of the locking position can be detected by sensors with the respective sensor signal ensuring in the invention that the gear between the drive motor and the drive means changes to another torque level, depending on the signal. For this purpose, the described actuating means may for instance block the ring gear or planet carrier, depending on the signal, so that the flow of the force is reduced through the planet carrier or ring gear and forwarded to the drive means via the sun wheel.

This torque change actually corresponds to a gear reduction of for instance 8:1. Consequently the motor vehicle door moves along the pulling-closed path only at one eights of the speed compared to moving along the closing path without, however, any loss of comfort, as the pulling closed path is limited to a few millimeters or at most a few centimeters. The invention naturally includes also other gear reductions and consequently speed ratios.

The torque changeover does not only have to depend on the described sensor signal and/or actuating signal. Alternatively or in addition, load-dependent (and automatic) changeover is possible. This means that as soon as an increased torque is required on the output side of the drive means for moving the motor vehicle door or sliding door, the gear or planet gear of the invention switches (automatically) to the other gear reduction so that the movement of the motor vehicle door can be continued without interruption.

The described drive system is consequently characterized by an automatic detection of an increased load scenario in which either the reaching of the locked position or a certain predefined position of the motor vehicle door or increase of the torque required on the output side is detected, causing the torque change of the gear. Preferably, this torque change is automatic with the actuating means providing the coupling of the selected gear members by, for instance, means of a spring (to produce the desired reducing gear). Equally, the actuating means can also change the torque by means of an actuator, in which case said signal and/or sensor evaluation is mostly carried out in advance. Consequently also no trapping protection is required.

The trapping protection generally ensures that the drive means is switched off when an increased torque is detected at the output or when a contact positioned in the rubber door seal is closed. Equally, the power absorbed by the drive motor can be evaluated. By using the special gear and actuating means embodiments according to the invention can ensure that load scenarios “trapping”, “closing” or “pulling closed” can be distinguished.

Whilst moving across the closing path an increase in torque that corresponds to trapping is, for instance, not expected. In this case, the increased current consumption of the electric motor or the drive motor associated with the increasing torque at the output site, is interpreted in such a way that it is switched off. In case of a similar increase in torque when moving along the pulling-closed path, the motor may also be switched off in this case. These are the main advantages of the invention:

### BRIEF DESCRIPTION OF THE DRAWINGS

Below, the invention is explained in more detail using drawings representing only one embodiment, in which:

FIG. 1 provides an overview of the drive system of the invention

FIG. 2 is a detailed view of FIG. 1,

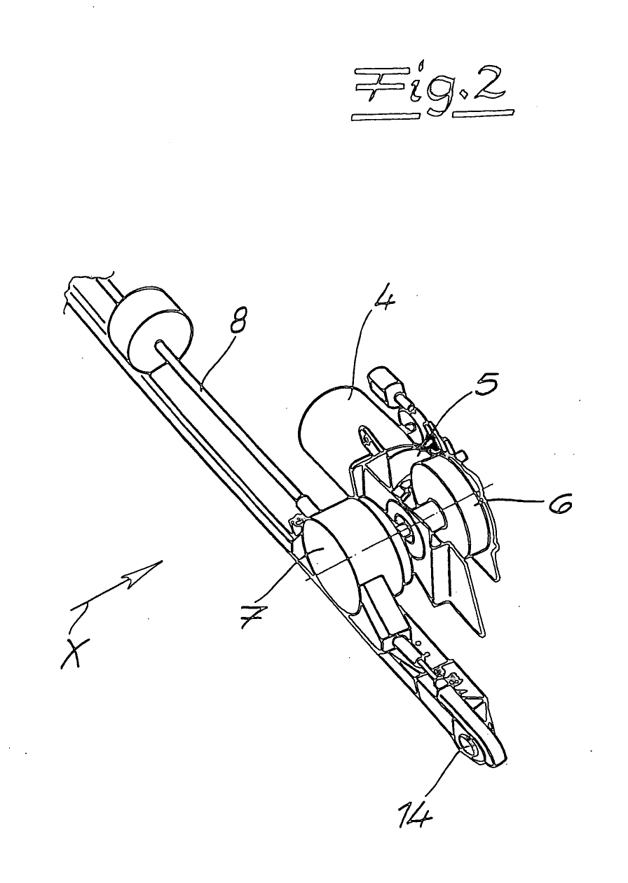

FIG. 3 is a view onto FIG. 2 from direction X,

FIG. 4 is a sectional view of a first embodiment of the gear according to the invention,

FIG. 5 is another embodiment of the gear,

FIG. 6 is a further modified embodiment of FIG. 5,

FIG. 7 is another view of FIG. 6 with removed ring gear and

FIG. 8 is a detailed section of FIG. 7.

### DETAILED DESCRIPTION OF THE PREFERRED EMBODIMENTS

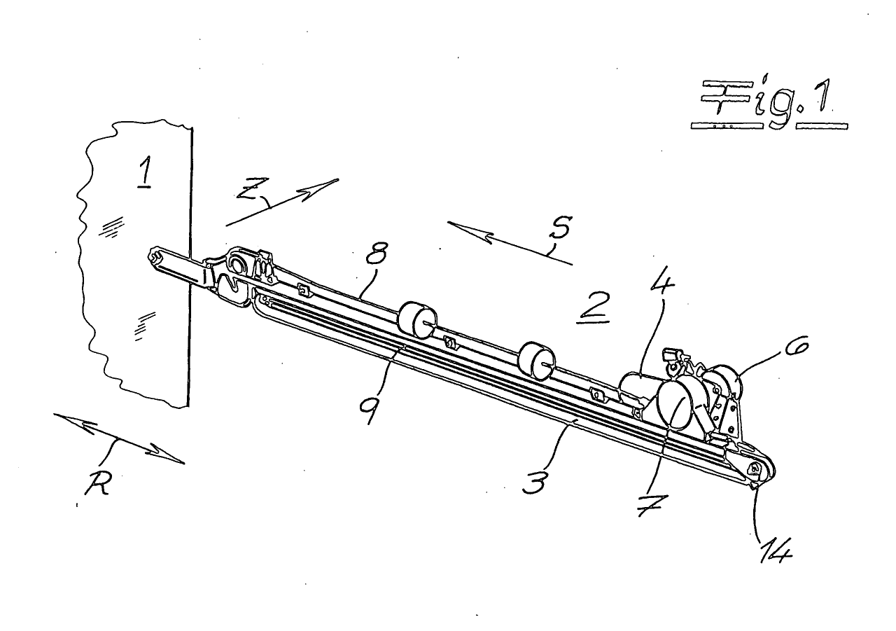

The figures show a drive system for a motor vehicle door 1. Motor vehicle door 1, of which only parts are indicated in FIG. 1, does not only refer to a sliding door 1, moved to and fro in longitudinal direction of the motor vehicle along a guide rail 3 parallel to the motor vehicle body 2 along an opening/closing path R. In order to provide this movement of the motor vehicle door 1 or sliding door 1, a drive motor 4 and a connected drive means 6, 7, 8, 9 is provided. Between the drive motor 4, which is an electric motor 4 and the drive means 6, 7, 8, 9 the invention provides a gear 5, which is explained in detail below.

The drive means 6, 7, 8, 9 comprises a worm gear 6 and a winding reel 7 connected to the worm gear 6 as well as a cable pull 8, 9 consisting of an upper cable pull 8 and a lower cable pull 9, wound onto and unwound from the winding reel 7. Moving the cable pull 8, 9 to and fro causes the motor vehicle door or sliding door 1 to move into its closed position as shown in FIG. 1 and allows movement into its open position along the guide rail 3 and back along opening/closing path R. This is indicated by the respective double arrow in FIG. 1. Respective movement of the motor vehicle door 1 can be initiated from a remote control (not shown), used for acting upon the drive motor 4, equipped with a logical reversing function.

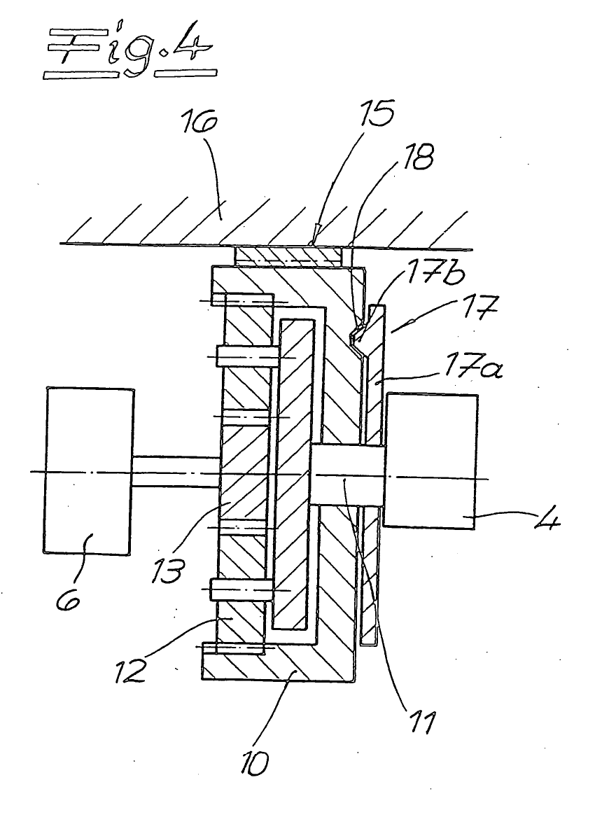

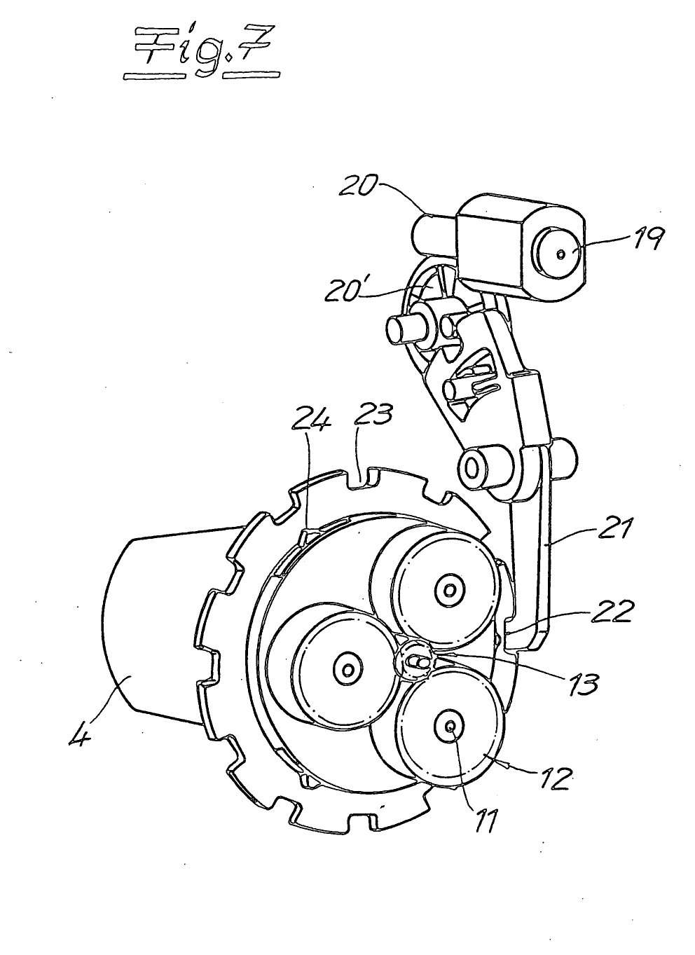

According to the invention, the already discussed gear 5 is provided between the drive motor 4 and the drive means 6, 7, 8, 9 with the said gear being a planet gear 10, 11, 12, 13 in the figures (see FIGS. 4 and 7). The planet gear 10, 11, 12, 13 actually comprises a ring gear 10, a planet carrier 11, planet wheels 12 as well as a sun wheel 13. With the aid of gear 5 or planet gear 10, 11, 12, 13 the drive motor 4 is able to apply different torques onto the drive means 6, 7, 8, 9 for acting upon the motor vehicle door 1. The change from the 6/12 different torques produced by gear 5 and respective planet gear 10, 11, 12, 13 is load and/or signal-dependent.

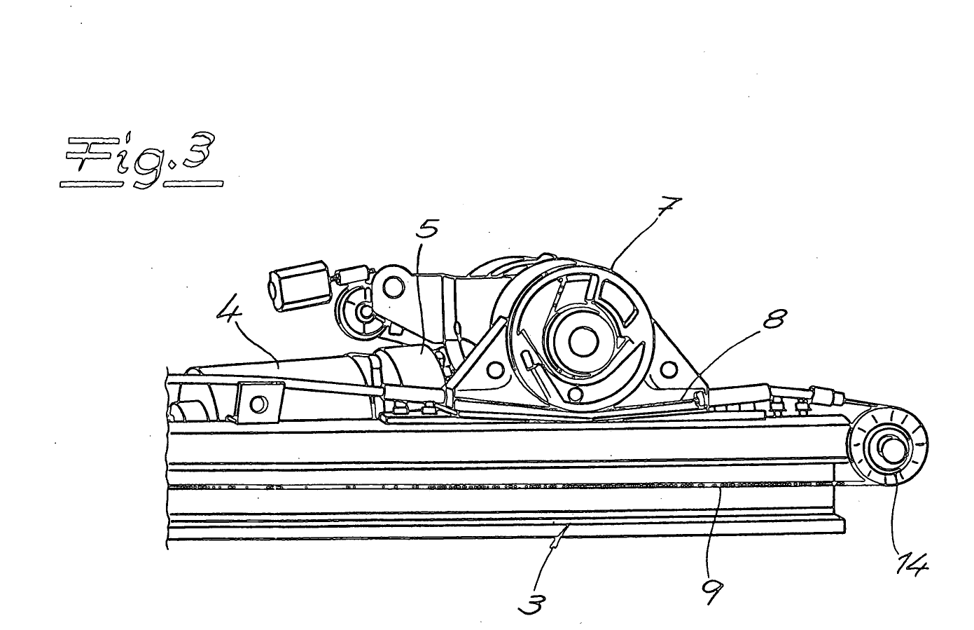

To and fro movement of the cable or steel cable 8, 9 is made possible by the fact that both cable pulls 8, 9 run around a deflection pulley 14 at the end of guide rail 3, so that the motor vehicle door 1 moves along guide rail 3 as indicated by the double arrow R in FIG. 1, as also apparent from FIG. 3

A load-dependent and automatic torque change of the planet gears 10, 11, 12, 13 is shown in the embodiment in FIG. 4. Here it is apparent that at this stage a free-wheel 15 is provided between a ring gear 10 and a housing 16. Also an actuating means 17 is provided, coupling individual selected gear members of the planet gears 10, 11, 12, 13 depending on the load on the output side. In the embodiment shown in FIG. 1, the actuating means 17 is spring-assisted and is shown in the figure as spring leg 17a with projection 17b. The projection 17b functionally engages in recess 18 of the ring gear 10.

The planet carrier 11 is connected to the drive motor 4, whilst the sun wheel 13 of the planet gear 10, 11, 12, 13 acts upon the drive means 6, 7, 8, 9, or more accurately, the worm gear 6.

During normal operation, the sun wheel 13, ring gear 10, planet carrier 11 and the planet wheels 12 form a quasi rigid module 10, 11, 12, 13 so that drive motor 4 practically acts 1:1 upon the worm gear 6 and consequently on the drive means 6, 7, 8, 9 for moving the motor vehicle door 1. If on the other hand the load increases on the load side, i.e. in the area of the drive means 6, 7, 8, 9 or its worm gear 6, the torque is increased within planet gear 10, 11, 12, 13. This is achieved with the free-wheel 15, allowing rotation of the driven ring gear 10 during normally applied torques.

If, however, the torque on the drive means 6, 7, 8, 9 increases, the free-wheel 15 blocks the ring gear 10, so that the planet wheels 12 that before turned together with the ring gear 10 now revolve inside it. At the same time, the planet carrier 11 turns in relation to the ring gear 10 and the drive motor 4 acts upon the planet carrier 11 and planet wheels 12 and finally upon the sun wheel 13 and the connected worm gear 6. This results in a gear reduction or increased torque on the output side, which is used by the invention to move the door along a pulling-closed path Z after the closing path S, as diagrammatically indicated in FIG. 1.

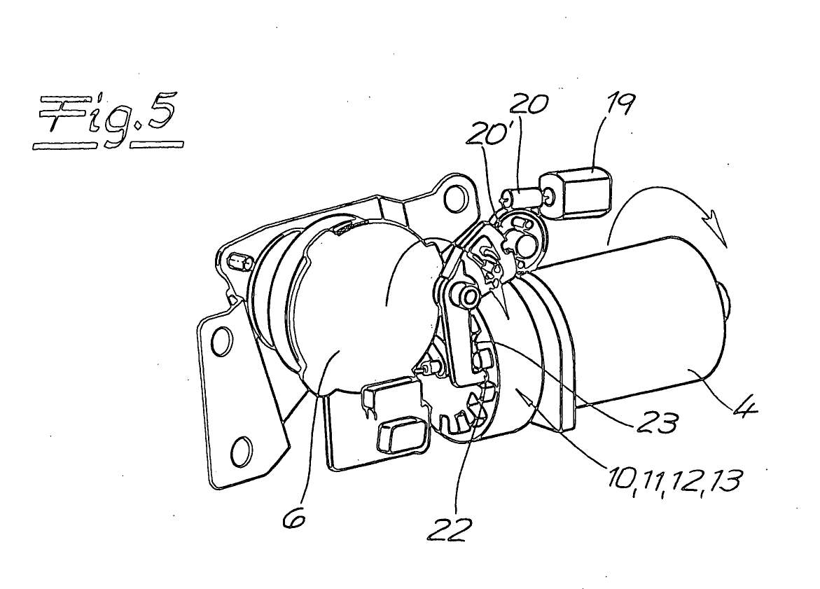

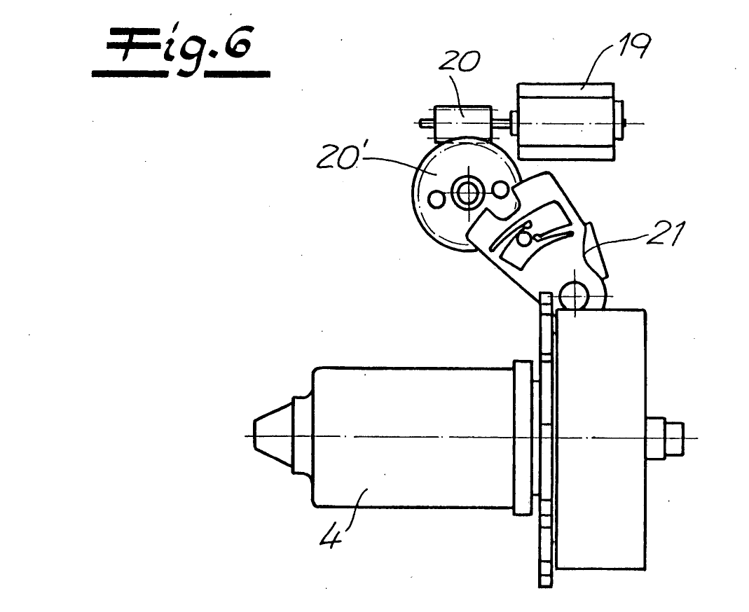

Instead of a load-dependent change of the gear 5 or planet gear 10, 11, 12, 13, also other actuating means 19, 20, 21 can be used to block the ring gear 10 of the planet gear 10, 11, 12, 13 with the described consequences. For this purpose the actuating means 19, 20, 22 engages in the ring gear 10 as shown in FIG. 5. Alternatively, the actuating means 19, 20, 21 can also block the planet carrier 11 as shown in FIG. 6 and 7.

In both cases the actuating means 19, 20, 21 comprises in this embodiment an actuator 19, a worm 20, possibly a cam wheel 20′ and a blocking lever 21 acted upon by worm 20, although the invention is not limited to this arrangement. The blocking lever 21 engages with a projection 22 in the recess 23 on the planet carrier 11 (see FIGS. 6 and 7) or on the ring gear 10 (see FIG. 5). This blocks the ring gear 10 or planet carrier 11 so that the power from the drive motor flows in the first case via the planet carier 11, planet wheels 12 and finally the sun wheel 13 to the worm gear 6. In the second case the drive motor 4 drives the ring gear 10, planet wheels 12 and finally the sun wheel 13 with the connected worm gear 6.

In both cases the torque provided by the drive motor 4 is stepped down as required for overcoming the loads arising when moving along the pulling-closed path Z (caused for instance by the surrounding rubber door seal to be compressed).

It is apparent that different torques of gear 5 are used for moving along the closing path S and the pulling-closed path Z. The change-over between these torques of gear 5 is either automatic, with the load scenario being detected as shown in FIG. 4 where the spring-assisted coupling 17 and the free-wheel 15 secures the previously unblocked gear 10. Alternatively or in addition, the actuating means 19, 20, 21 and the blocking lever 21 can also specifically block the gear member (ring gear 10 or planet carrier 11). In this case, a sensor signal and/or actuating signal in the obligatory motor vehicle door latch can be evaluated, showing that the locked position has been attained (first or primary position). Consequently no trapping protection is required, as whilst the motor vehicle door 1 moves for instance along the closing path S, no increased torque may occur. Where the torque does, however, increase and the current received from the drive motor 4 rises, this condition may correspond to jamming and causes automatic deactivation of the drive motor 4.

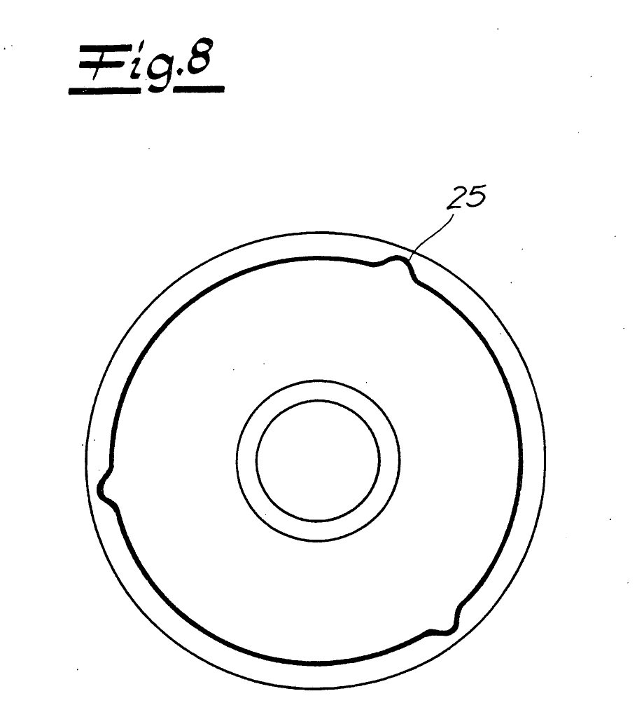

It is obvious that the actuating means 17 or 19, 20, 21 can in principle be of any design as long as it is ensured that the desired gear member (ring gear 10 or planet carrier 11) is blocked as required for changing over to the increased torque. In addition, circumferential springs 24 in or on the planet carrier 11 as shown in FIG. 7 and 8 ensure that the planet carrier 11 returns to a defined (and specified) position after its rotation once it is no longer blocked by the actuating means 19, 20, 21. For this purpose, springs 24 can enter housing recesses 25 to ensure that it is blocked.

1. A drive system for a motor vehicle door (1), in particular a sliding door (1), including a drive motor (4) and a connected drive means (6, 7, 8, 9) for moving the motor vehicle door (1) along an opening/closing path (R), comprising: a gear (5) provided between the drive motor(4) and drive means (6, 7, 8, 9),for acting with different torques on the drive means (6, 7, 8, 9) depending on load and/or a signal.

2. The drive system according to claim 1, wherein an actuating means (17; 19, 20, 21) is provided affecting coupling of individually selected gear members (10, 11, 12, 13).

3. The drive system according to claim 2, wherein the actuating means (17; 19, 20, 21) is spring-assisted and/or uses an actuator (19) for coupling the selected gear members (10, 11, 12, 13).

4. The drive system according to claim 1, wherein the gear (5) is a planet gear (10, 11, 12, 13) comprising at least a ring gear (10), planet carrier (11), planet wheels (12) and sun wheel (13).

5. The drive system according to claim 2, wherein the gear (5) is a planet gear (10, 11, 12, 13) comprising at least a ring gear (10), planet carrier (11), planet wheels (12) and sun wheel (13) and wherein for producing different torques of the gear (5) the actuating means (17, 19, 20, 21) engages with the ring gear (10) and/or planet carrier (11).

6. The drive system according to claim 5, wherein the gear (5) is connected to the drive means (6, 7, 8, 9) with its sun wheel (13), whilst the drive motor (4) acts upon the planet carrier(11) and/or the ring gear (10).

7. The drive system according to claim 1, wherein the opening/closing path (R) for the motor vehicle door (1) comprises a closing path (S) and a pulling-closed path (Z) and that the door is moved along both paths (S, Z) with different torques of the gear (5).

8. The drive system according to claim 1, wherein a switching between the different torques is triggered by a sensor and/or actuating signal.
